(19) United States
(12) Patent Application Publication
(10) Pub. No.: US 2023/0050240 A1
(43) Pub. Date: Feb. 16, 2023

(54) PASSIVE ACCESS CALIBRATION

(71) Applicant: FORD GLOBAL TECHNOLOGIES, LLC, Dearborn, MI (US)

(72) Inventors: Michael Andrew SIMONS, Redford, MI (US); Brian Y. WILKERSON, Canton, MI (US); Yong KONG, Troy, MI (US)

(21) Appl. No.: 17/398,726

(22) Filed: Aug. 10, 2021

(51) Int. Cl. B60R 25/24; H04W 4/021; H04W 4/02; H04W 4/48; B60R 25/102

(52) U.S. Cl. CPC B60R 25/24; H04W 4/022; H04W 4/023; H04W 4/48; B60R 25/102

(57) ABSTRACT

Configuration of signal strength calibration offset is provided. A user interface is displayed, to a screen of a mobile device, for configuration of a signal strength offset of a wireless transceiver to a vehicle, the signal strength offset being an offset with respect to a default calibration of signal strength measurements between the wireless transceiver and the vehicle, the signal strength calibration being for use in calibrating a location of the mobile device for a passive zone with respect to the vehicle. An update to the signal strength calibration is received from the user interface. The signal strength calibration as updated is sent to the vehicle for use in locating the mobile device for the passive zone.

### TECHNICAL FIELD

Aspects of the present disclosure generally relate to phone-based key (PBK) systems and, in particular, to calibration of PBK systems using a smartphone or other mobile device.

### BACKGROUND

Vehicle key fobs may be used to allow a user to gain access to a vehicle. Some fob devices operate such that when a key is pressed on the fob, the device sends a code to the vehicle to instruct the vehicle to unlock the vehicle. Passive-entry key fobs operate to provide response to a challenge pulse train sent by the vehicle, where, if a proper response is received by the vehicle, then the door may be unlocked by a user grasping the door handle. PBK systems allow users to utilize their phones to unlock a vehicle without requiring a key fob device. These systems may operate similar to a key fob, but where the phone communicates with the vehicle over BLUETOOTH or other wireless technologies.

### SUMMARY

In one or more illustrative examples, a mobile device for configuration of signal strength calibration offset is provided. A wireless transceiver configured for location of the mobile device by a vehicle. A processor programmed to display a user interface for configuration of a signal strength offset of the wireless transceiver to the vehicle, the signal strength offset being an offset with respect to a default calibration of signal strength measurements between the wireless transceiver and the vehicle, the signal strength calibration being for use in calibrating the location of the mobile device with respect to the vehicle. The processor is further programmed to receive an update to the signal strength calibration from the user interface, and send the signal strength calibration as updated to the vehicle for use in locating the mobile device.

In one or more illustrative examples, a method for configuration of signal strength calibration offset is provided. A user interface is displayed, to a screen of a mobile device, for configuration of a signal strength offset of a wireless transceiver to a vehicle, the signal strength offset being an offset with respect to a default calibration of signal strength measurements between the wireless transceiver and the vehicle, the signal strength calibration being for use in calibrating a location of the mobile device for a passive zone with respect to the vehicle. An update to the signal strength calibration is received from the user interface. The signal strength calibration as updated is sent to the vehicle for use in locating the mobile device for the passive zone.

In one or more illustrative examples, a non-transitory computer-readable medium includes instructions for configuration of signal strength calibration offset, that, when executed by a processor of a mobile device, cause the mobile device to perform operations including to display, to a screen of a mobile device, a user interface for configuration of a signal strength offset of a wireless transceiver to a vehicle, the signal strength offset being an offset with respect to a default calibration of signal strength measurements between the wireless transceiver and the vehicle, the signal strength calibration being for use in calibrating a location of the mobile device for a passive zone with respect to the vehicle; receive an update to the signal strength calibration from the user interface; and send the signal strength calibration as updated to the vehicle for use in locating the mobile device for the passive zone.

### BRIEF DESCRIPTION OF THE DRAWINGS

FIG. 1 illustrates an example system for distribution of a consumer access key for use calibration of PBK systems;

FIG. 2 illustrates an example portion of the access control system including further details of the vehicle and the mobile device;

FIG. 3A illustrates an example user interface of the passive key application for configuration of the calibration offset for a passive entry zone;

FIG. 3B illustrates an example user interface responsive to user selection of the calibrate passive entry control;

FIG. 4A illustrates an example user interface for configuration of the calibration offset for a passive start zone;

FIG. 4B illustrates an example user interface responsive to user selection of the calibrate passive start control;

FIG. 5 illustrates an example user interface of administrator calibration settings for the vehicle;

FIG. 6 illustrates an example process for the configuration of the calibration offset settings for the mobile device.

FIG. 7 illustrates an example process for the configuration of administrator calibration settings for the vehicle; and

FIG. 8 illustrates an example computing device for the use in the configuration of the calibration offset settings for the mobile device.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

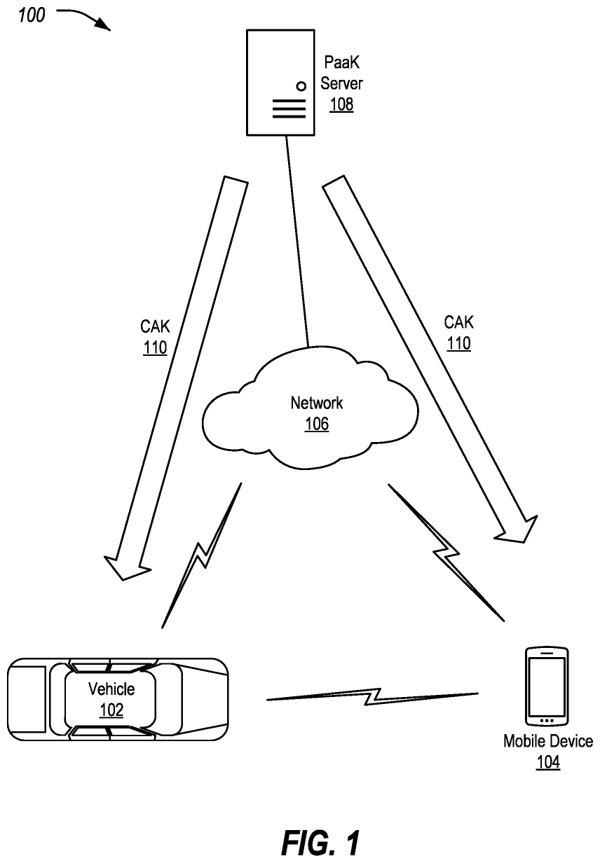

FIG. 1 illustrates an example access control system 100 for distribution of a Consumer Access Key (CAK) 110 for use in calibration of PBK systems. As described herein, PBK systems and methods perform user authentication through the use of the CAK 110. In such a system, a phone-as-a-key (PaaK) server 108 may issue a CAK 110 to both a vehicle 102 and to a mobile device 104 for use in authentication. To perform the authentication, the vehicle 102 may confirm that the CAK 110 offered by the mobile device 104 matches or otherwise corresponds to a CAK 110 maintained by the vehicle 102. If so, access to the vehicle 102 may be granted to the user of the mobile device 104. If not, access may be denied.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a battery electric vehicle (BEV) powered by one or more electric motors. As a further possibility, the vehicle 102 may be a hybrid electric vehicle (HEV) powered by both an internal combustion engine and one or more electric motors, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs).

The vehicle 102 may include a plurality of controllers configured to perform and manage various vehicle 102 functions under the power of the vehicle battery and/or drivetrain. As some non-limiting vehicle controller examples: a powertrain controller may be configured to provide control of engine operating components (e.g., idle control components, fuel delivery components, emissions control components, etc.) and for monitoring status of such engine operating components (e.g., status of engine codes); a body controller may be configured to manage various power control functions such as exterior lighting, interior lighting, keyless entry, remote start, and point of access status verification (e.g., closure status of the hood, doors and/or trunk of the vehicle 102); a radio transceiver controller may be configured to communicate with key fobs, mobile devices, or other local vehicle 102 devices; an autonomous controller may be configured to provide commands to control the powertrain, steering, or other aspects of the vehicle 102; a climate control management controller may be configured to provide control of heating and cooling system components (e.g., compressor clutch, blower fan, temperature sensors, etc.); a global positioning system (GPS) controller may be configured to provide vehicle location information; and a human-machine interface (HMI) controller may be configured to receive user input via various buttons or other controls, as well as provide vehicle status information to a driver, such as fuel level information, engine operating temperature information, and current location of the vehicle 102.

The vehicle bus may include various methods of communication available between the vehicle controllers, as well as between the telematics control unit (TCU) and the vehicle controllers. As some non-limiting examples, a vehicle bus may include one or more of a vehicle controller area network (CAN), an Ethernet network, and a media-oriented system transfer (MOST) network. Further aspects of the layout and number of vehicle buses are discussed in further detail below. The TCU may include network hardware configured to facilitate communication between the vehicle controllers and with other devices of the access control system 100. For example, the TCU may include or otherwise access a cellular modem configured to facilitate communication with other vehicles 102 or with infrastructure. The TCU may, accordingly, be configured to communicate over various protocols, such as with a communication network over a network protocol (such as Uu). The TCU may, additionally, be configured to communicate over a broadcast peer-to-peer protocol (such as PC5), to facilitate cellular vehicle-to-everything (C-V2X) communications with devices such as other vehicles 102. It should be noted that these protocols are merely examples, and different peer-to-peer and/or cellular technologies may be used.

The mobile device 104 may be any of various types of portable computing device, such as cellular phones, tablet computers, smart watches, laptop computers, portable music players, or other devices having processing and communications capabilities. The mobile device 104 may include one or more processors configured to execute computer instructions, and a storage medium on which the computer-executable instructions and/or data may be maintained.

The mobile device 104 may further include various wireless transceivers, such as a BLUETOOTH or BLUETOOTH Low Energy (BLE) transceiver, as well as a transceiver for communication over a communications network 106. The communications network 106 may include one or more interconnected communication networks such as the Internet, a cable television distribution network, a satellite link network, a local area network, and a telephone network, as some non-limiting examples.

The PaaK server 108 may be another example of a networked computing device that is accessible to the vehicle 102 and/or the mobile device 104 over the communications network 106. The CAK 110 may be an encryption key configured for the vehicle 102 and the mobile device 104 to identify and authenticate each other for access to the vehicle. As shown, the CAK 110 is provided over the communications network 106 from the PaaK server 108 to a vehicle 102 and to a mobile device 104.

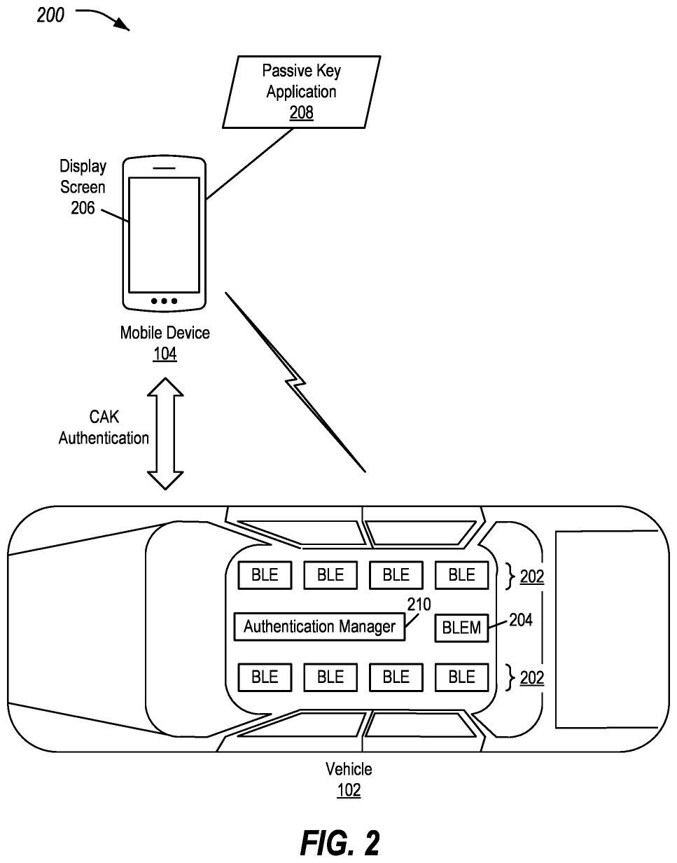

FIG. 2 illustrates an example portion of the access control system 100 including further details of the vehicle 102 and the mobile device 104. As shown, the vehicle 102 may include an array of BLE transceivers 202 configured to facilitate communication between the mobile device 104 and the vehicle 102. For instance, each BLE transceiver 202 may be connected to one or more antennas to form an array that may be used to triangulate or otherwise detect the location of the mobile device 104. The BLE transceivers 202 may be controlled by a BLE module (BLEM) 204 including a memory and a processor programmed to send and receive messaging between the mobile device 104 and the vehicle 102, e.g., to provide for the performance of challenge-response sequences and/or to receive commands from the vehicle 102. In an example, a key fob may connect to the closest-detected BLE transceiver 202 to communicate with the BLEM 204 of the vehicle 102. As shown the vehicle 102 includes eight BLE transceivers 202, but it should be noted that implementations may include more or fewer transceivers and/or antennas.

The mobile device 104 may also include a display 206 configured to provide a user interface to a user. In some examples, the display 206 may be touch-sensitive, and may be further configured to receive input from the user. Additionally, a passive key application 208 may include instructions that, when executed by the one or more processors of the mobile device 104, cause the mobile device 104 to perform operations to facilitate access to the vehicle 102. In an example, the passive key application 208 may cause the mobile device 104 to display a user interface to the display 206 including controls similar to those of a key fob, e.g., lock, unlock, start, etc. In another example, the passive key application 208 may cause the mobile device 104 to interact as a passive entry device with the vehicle 102, providing presence information to the BLEM 204 that allows the vehicle 102 to detect that an authorized user of the vehicle 102 is nearby. By executing the passive key application 208 to control communication of the mobile device 104 with the BLEM 204 of the vehicle 102, the mobile device 104 may be used to unlock, start, or otherwise access the vehicle 102 using the CAK 110, without having to press controls on the mobile device 104.

The passive key application 208 may allow for the authentication of the mobile device 104 to the vehicle 102 using an authentication manager 210 of the vehicle 102. The authentication manager 210 may include software that manages the authentication status of the CAK 110 to the vehicle 102. The authentication manager 210 may request other software services, based off of an authentication status, to trigger or drive the actions in the vehicle 102. This software may be executed by a controller of the vehicle 102 that is in communication with the BLEM 204, as well as with other components of the vehicle 102, such as door locks or vehicle ignition interlock. The authentication of the mobile device 104 to vehicles 102 may utilize a PaaK feature implementation, ensuring a secure connection between the user mobile device 104 and a vehicle connectivity module (such as the BLEM 204), whereby the user position can be localized utilizing the BLE transceiver 202 antennas. Moreover, the BLE link layer encryption may add communication security.

To provide for localization, aspects of the communications between the BLE transceiver 202 and the mobile device 104 may be measured. These aspects may include, in an example, Received Signal Strength Indicator (RSSI) measurements of the communications. For instance, the higher the signal strength between the mobile device 104 and the BLE transceiver 202, the closer the mobile device 104 likely is to the vehicle 102. A function may utilize a relationship between mobile device 104 signal strength and distance to determine a position of the mobile device 104 relative to the vehicle 102.

Some mobile devices 104 may measure with different RSSI as compared to other mobile devices 104. For instance, a first mobile device 104 of a first manufacturer may be constructed with different antenna characteristics and/or gain settings as compared to a second mobile device 104 of a second manufacturer. Or, one user of a mobile device 104 may carry the mobile device 104 in a hand or pocket that provides for minimal loses, while another user of the same type of mobile device 104 may carry the mobile device 104 in a purse, briefcase, or other manner that involves greater loss in signal strength. Thus, all else being equal, mobile devices 104 may be determined by the vehicle 102 to be at different distances despite being at the same location relative to the vehicle 102.

To address these issues, a calibration process may be provided for mobile devices 104. This process may be performed to determine a calibration offset from a default calibration which may be applied to RSSI measurements for the mobile device 104. This RSSI offset may be determined empirically (or automatically through various training mechanisms) as new types of mobile device 104 become available. In an example, the calibration offset may be determined based on the type of the mobile device 104 and may be used to compensate for differences due to the construction of the mobile device 104 type.

With respect to the default calibration, in some examples the default calibration may be further based on aspects of a customer profile of the user of the mobile device 104. For instance, if the user of the mobile device 104 indicates a preference for security over performance then the default calibration may set the default settings to limit the performance to a shorter range. However, if the user of the mobile device 104 indicates a preference for performance over security then the default calibration might be set to have an expanded range. In an example, the preference may be set up in a profile via the passive key application 208. In another example, the preference may be extracted from a 3^{rd} party application or user profile per the user's consent.

Localization of the mobile device 104 with the CAK 110 delivered may therefore be performed in an improved manner according to the calibration offset. Yet, due to differences in other factors, such as the how the mobile device 104 is used by the user or obstructions of the BLE transceivers 202 of the vehicle 102, this offset may perform differently per vehicle 102 and/or per user. Thus, it may be desirable to fine-tune the calibration offset to ensure the proper operation of the localization of the mobile device 104 for passive entry features. Moreover, with the ever-increasing types of mobile device 104 with varying degrees of BLUETOOTH chipsets, it may be unmanageable to calibrate every mobile device 104 for every vehicle 102.

To further improve the calibration offset, a CAK 110 based calibration on the mobile device 104 side may be used that controls the calibrated offset value of the mobile device 104 that is used by the mobile device 104 to send RSSI to the vehicle 102. This may offer a mutable offset value that can be set on an individual mobile device 104 basis to work with connected vehicles 102 to allow a user to control the distance at which a passive entry feature may function (or if it is disabled, e.g., for security purposes).

The mobile device 104 may send a message to the BLE module 204 of the vehicle 102 to enable a configuration mode. In the configuration mode, the vehicle 102 may receive offset values from the mobile device 104 to adjust the zones of user access such as passive entry and passive start (as well as potentially other location-based triggers such as a welcome mode where vehicle 102 illumination or other features activate responsive to user proximity). With the mobile device 104 in a predetermined location, upon receiving an indication of a desired transition between zones, such as a connected passive entry zone to a driver passive start zone, the vehicle 102 may send a message to the mobile device 104 containing the calibrated offset for its BLE system.

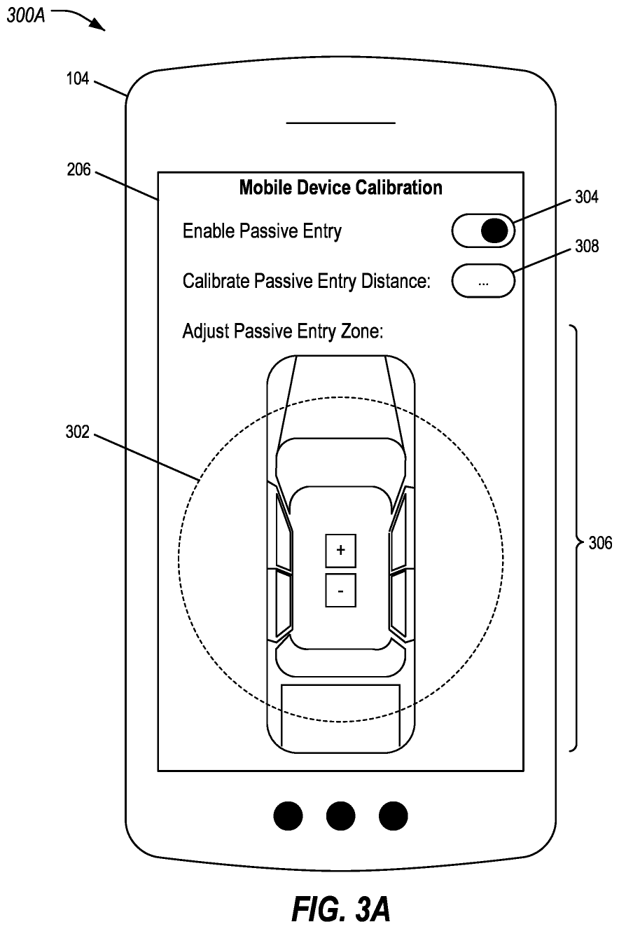

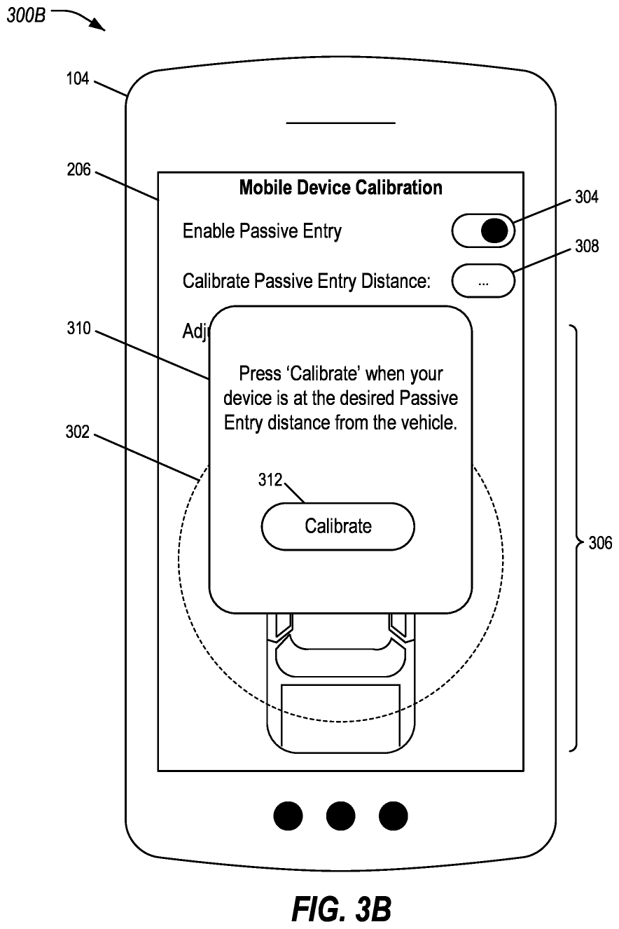

FIG. 3A illustrates an example user interface 300A of the passive key application 208 for configuration of the calibration offset for a passive entry zone 302. The user interface 300A may be shown to the display 206 of the mobile device 104 responsive to user selection to configure the phone calibration. Using the user interface 300A, a user of the mobile device 104 having the CAK 110 for use with the vehicle 102 may turn on or off use of the passive entry zone 302, as well as make changes to the sensitivity of the mobile device 104 detection with respect to the passive entry zone 302.

In an example, the passive key application 208 may display an enable/disable passive entry control 304 to allow a user to select whether or not the CAK 110 may be used by the mobile device 104 to provide for passive entry to the vehicle 102. For instance, the enable/disable passive entry control 304 may have a first setting in which the passive entry passive entry zone 302 for the vehicle 102 is used for providing access to the vehicle 102 via the CAK 110, and a second setting in which the passive entry passive entry zone 302 for the vehicle 102 is not used and the user instead is required to use other approaches to gain access to the vehicle 102.

The passive key application 208 may also display an adjust passive entry control 306 from which the relative sensitivity of the mobile device 104 detection may be adjusted. For instance, the adjust passive entry control 306 may include controls to increase [+] or decrease [−] the calibration offset for the passive entry zone 302. The user interface 300A may further visualize the change to the passive entry zone 302 by increasing or decreasing the size of the visualization of the passive entry zone 302. This may allow the user to visually see the increase or decrease in the calibration offset.

The passive key application 208 may further display a calibrate passive entry control 308 that, when selected, allows the user to configure the calibration offset with respect to the current position of the mobile device 104. Referring to FIG. 3B, a user interface 300B is shown responsive to user selection of the calibrate passive entry control 308. As shown, a calibrate passive entry popup 310 is displayed including a calibrate passive entry button 312. The calibrate passive entry popup 310 may indicate to the user to press the calibrate passive entry button 312 after placing the mobile device 104 at a desired distance from the vehicle 102 for operation of the passive entry zone 302. Responsive to user selection of the calibrate passive entry button 312, the mobile device 104 may request the vehicle 102 to provide the mobile device 104 a calibration offset consistent with the present location of the mobile device 104. For instance, the vehicle 102 may determine the current RSSI of the mobile device 104 to the BLE transceivers 202 and may subtract that from the default calibration offset to determine the proper calibration offset for the mobile device 104. In an example, the mobile device 104 may make the request and the vehicle 102 may send the determined offset over the BLE connection.

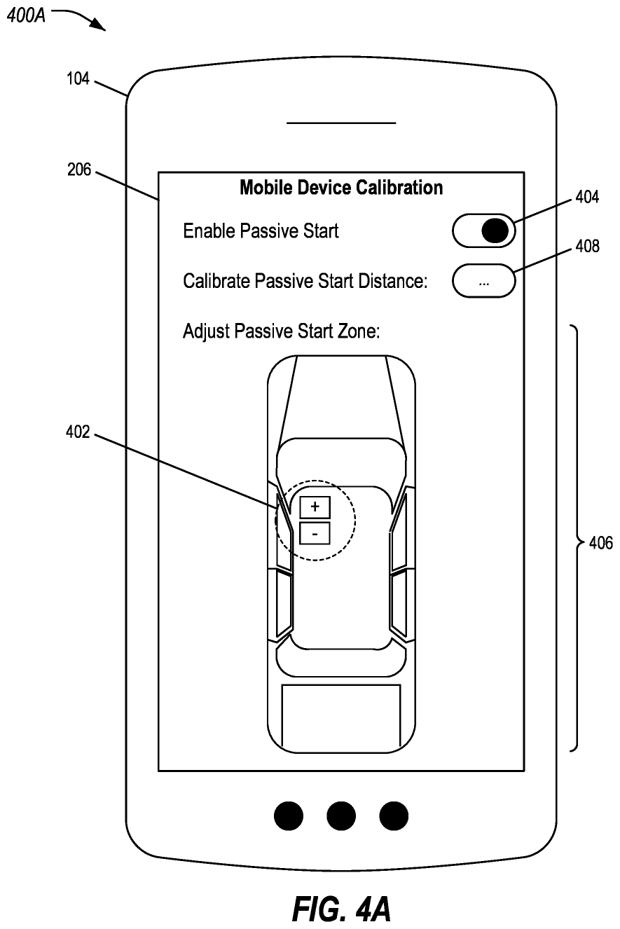

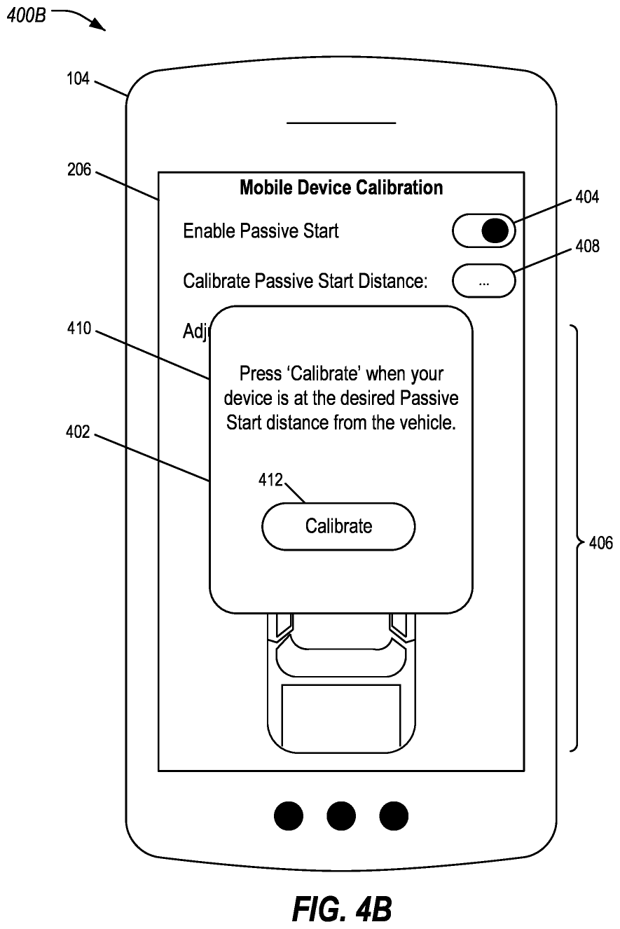

FIG. 4 illustrates an example user interface 400A of the passive key application 208 for configuration of the calibration offset for a passive start zone 402. As with the user interfaces 300A and 300B, a user interface 400A may be shown to the display 206 of the mobile device 104 responsive to user selection to configure the phone calibration. Using the user interface 400A, a user of the mobile device 104 having the CAK 110 for use with the vehicle 102 may turn on or off use of the passive start zone 402, as well as make changes to the sensitivity of the mobile device 104 detection with respect to the passive start zone 402.

In an example, the passive key application 208 may display an enable/disable passive start control 404 to allow a user to select whether or not the CAK 110 may be used by the mobile device 104 to provide for passive entry to the vehicle 102. The passive key application 208 may also display an adjust passive start control 406 from which the relative sensitivity of the mobile device 104 detection may be adjusted. For instance, the adjust passive start control 406 may include controls to increase [+] or decrease [−] the calibration offset for the passive start zone 402. The user interface 400A may further visualize the change to the passive start zone 402 by increasing or decreasing the size of the visualization of the passive start zone 402 to allow the user to visually see the increase or decrease in the calibration offset.

The passive key application 208 may further display a calibrate passive start control 408 that, when selected, allows the user to configure the calibration offset with respect to the current position of the mobile device 104. Referring to FIG. 4B, a user interface 400B is shown responsive to user selection of the calibrate passive start control 408. As shown, a calibrate passive start popup 410 is displayed including a calibrate passive start button 412. The calibrate passive start popup 410 may indicate to the user to press the calibrate passive start button 412 after placing the mobile device 104 at a desired distance from the vehicle 102 for operation of the passive start zone 402. Responsive to user selection of the calibrate passive start button 412, the mobile device 104 may request the vehicle 102 to provide the mobile device 104 a calibration offset consistent with the present location of the mobile device 104. For instance, the vehicle 102 may determine the current RSSI of the mobile device 104 to the BLE transceivers 202 and may subtract that from the default calibration offset to determine the proper calibration offset for the mobile device 104. In an example, the mobile device 104 may make the request and the vehicle 102 may send the determined offset over the BLE connection.

It should be noted that configuration of the passive entry zone 302 and the passive start zone 402 are examples, and other zones may be similarly configured. For instance, a welcome zone for turning on vehicle 102 lights as the user approaches may be configured similarly. Or, access zones for passenger features may be similarly configurable.

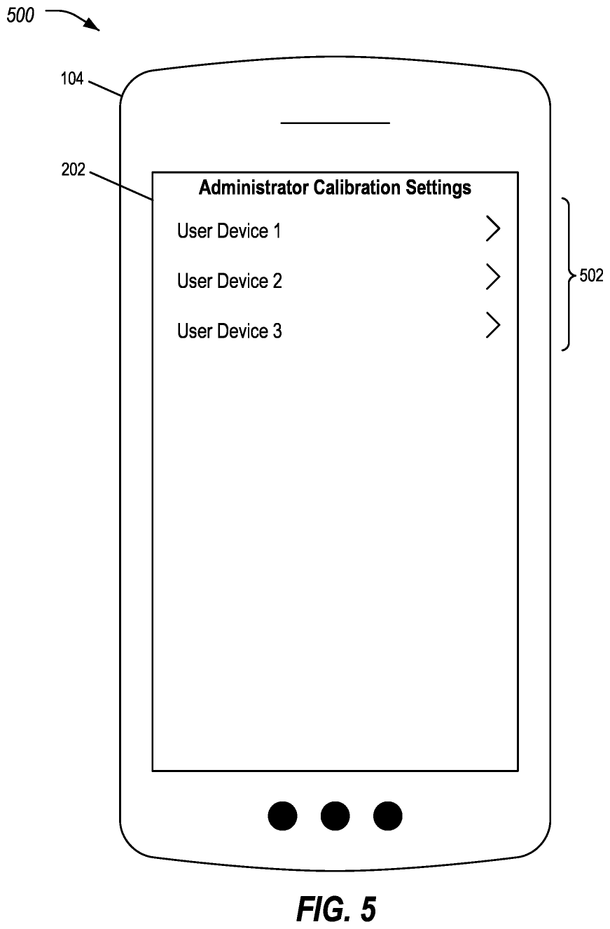

FIG. 5 illustrates an example user interface 500 of administrator calibration settings for the vehicle 102. In an example, the user interface 500 may be displayed by the passive key application 208 of the mobile device 104 responsive to selection of an administrator view from the passive key application 208 by an administrator of the vehicle 102. As shown, the user interface 500 may show a user listing 502 of authorized mobile devices 104 having a CAK 110 for access to the vehicle 102. In one example, the user listing 502 may be populated with information provided to the admin user mobile device 104 responsive to connection of the mobile device 104 to the vehicle 102. The illustrated user listing 502 includes three mobile device 104, where calibration offset settings for the mobile device 104 may be adjusted responsive to administrator selection of the corresponding device from the user listing 502.

In one example, the settings for the mobile device 104 may be configured by the administrator using user interfaces similar to the user interfaces 300A, 300B, 400A, and 400B. For instance, the administrator may access the administrator view from the passive key application 208 while local to the vehicle 102, e.g., by sending a message to the BLE module 204 of the vehicle 102 to enable the configuration mode. In another example, the administrator may access the administrator view of the configuration mode remotely. For instance, the mobile device 104 may communicate with the vehicle 102 via the PaaK server 108 to provide messages to remotely configure the calibration offsets.

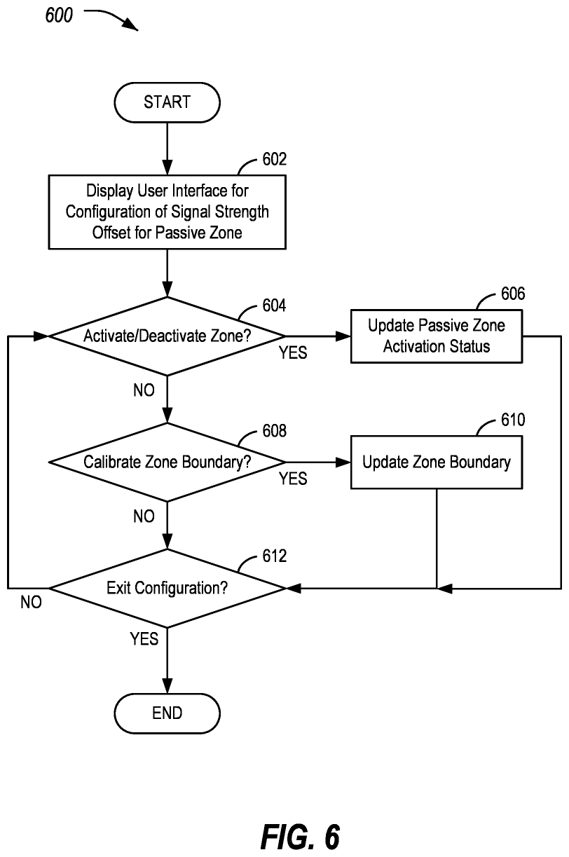

FIG. 6 illustrates an example process 600 for the configuration of the calibration offset settings for the mobile device 104. In an example, the process 600 may be performed by the mobile device 104 of a user having a CAK 110 providing access to the vehicle 102.

At operation 602, the mobile device 104 displays a user interface for the configuration of a signal strength offset for a passive zone. In an example, the passive zone may be a passive entry zone 302. In another example, the passive zone may be a passive start zone 402. In yet a further example the passive zone may be a different zone, such as a welcome zone. The passive key application 208 of the mobile device 104 may display one or more of the user interfaces 300A, 300B, 400A, or 400B responsive to user selection to configure calibration offset settings for the mobile device 104.

At operation 604, the mobile device 104 determines whether to activate or deactivate a passive zone. The determination whether to activate or deactivate the zone may be based on user selection of a control such as the enable/disable passive entry control 304 or the enable/disable passive start control 404. If the mobile device 104 receives an indication to activate or deactivate a passive zone, control passes to operation 606 to perform the activation or deactivation. The activation or deactivation may include, in an example, sending a message from the mobile device 104 to the vehicle 102 indicating that the mobile device 104 (or the CAK 110 corresponding to the mobile device 104) is enabled or disabled for use the passive zone. After operation 606, or if no indication is received at operation 604, control passes to operation 608.

At operation 608, the mobile device 104 determines whether to update a boundary of the passive zone. The determination whether to activate or deactivate the zone may be based on user selection of a control such as the adjust passive entry controls 306 to increase [+] or decrease [−] the calibration offset for the passive entry zone 302 or the adjust passive start control 406 to increase [+] or decrease [−] the calibration offset for the passive start zone 402. In another example, the determination may be responsive to selection of the calibrate passive entry button 312 after placing the mobile device 104 at a desired distance from the vehicle 102 for operation of the passive entry zone 302. In yet a further example, the determination may be responsive to selection of the calibrate passive start button 412 after placing the mobile device 104 at a desired distance from the vehicle 102 for operation of the passive start zone 402. If the mobile device 104 receives an indication to update a boundary of the passive zone, control passes to operation 610 to perform the update. The update may include, in an example, sending a message from the mobile device 104 to the vehicle 102 indicating that the mobile device 104 (or the CAK 110 corresponding to the mobile device 104) is to use an updated calibration offset for the passive zone. After operation 610, or if no indication is received at operation 608, control passes to operation 612.

At operation 612, the mobile device 104 determines whether to exit configuration. For instance, the user may close the user interface or may otherwise exit the passive key application 208. If so, the process 600 ends. If not, control returns to operation 604 to continue the configuration of the calibration offset settings of the mobile device 104.

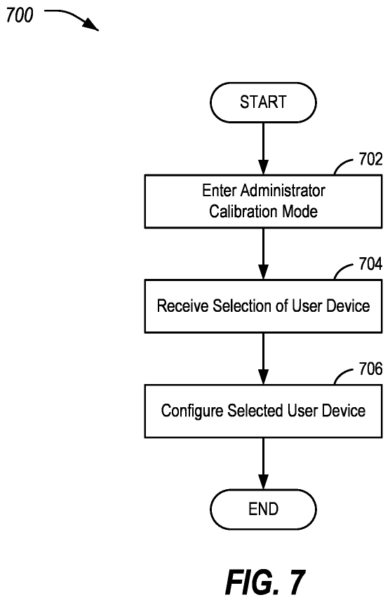

FIG. 7 illustrates an example process 700 for the configuration of administrator calibration settings for the vehicle 102. In an example, the process 700 may be performed by the mobile device 104 of an administrative user of the vehicle 102.

At operation 702, the mobile device 104 enters an administrator calibration mode for the vehicle 102. In an example, the user interface 500 may be displayed by the passive key application 208 of the mobile device 104 responsive to selection of an administrator view from the passive key application 208 by an administrator of the vehicle 102.

At operation 704, the mobile device 104 receives a selection of a user mobile device 104. As shown in the example of FIG. 5, the user interface 500 may show a user listing 502 of authorized mobile devices 104 having a CAK 110 for access to the vehicle 102. In one example, the user listing 502 may be populated with information provided to the admin user mobile device 104 responsive to connection of the mobile device 104 to the vehicle 102. The calibration offset settings for a mobile device 104 may be adjusted responsive to administrator selection of the corresponding device from the user listing 502.

At operation 706, the mobile device 104 configures the selected user mobile device 104. In one example, the settings for the mobile device 104 may be configured by the administrator using user interfaces similar to the user interfaces 300A, 300B, 400A, and 400B. After operation 706, the process 700 ends.

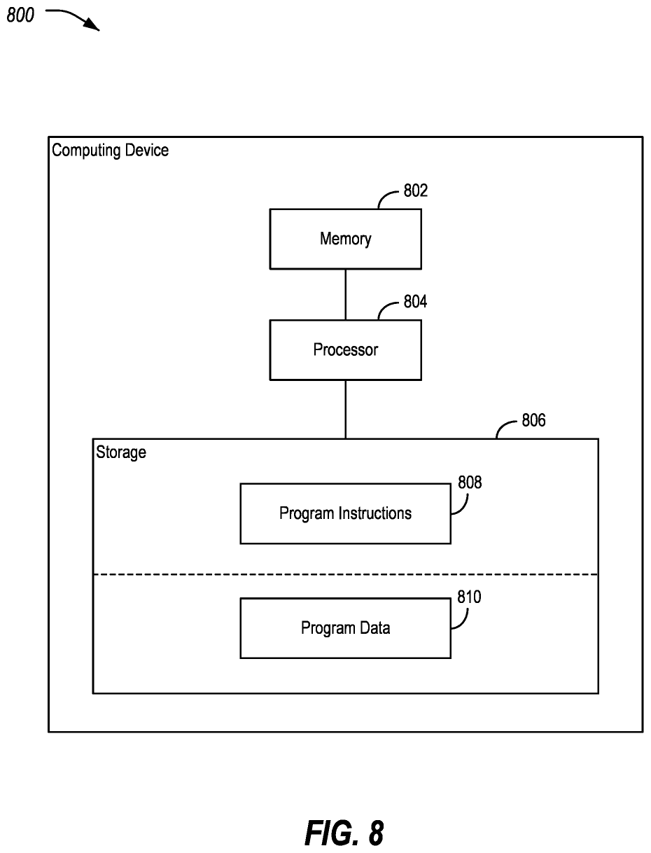

FIG. 8 illustrates an example computing device 800 for the use with keyed-alike CAKs 110. Devices discussed herein, such as the vehicle 102, mobile device 104, and PaaK server 108 may include devices such as the computing device 800. Likewise, the operations performed herein, such as those of the processes 600 and 700, may be implemented with such a computing device 800. The computing device 800 may include memory 802, processor 804, and non-volatile storage 806. The processor 804 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 802. The memory 802 may include a single memory device or a number of memory devices including, but not limited to, random access memory (RAM), volatile memory, non-volatile memory, static random-access memory (SRAM), dynamic random access memory (DRAM), flash memory, cache memory, or any other device capable of storing information. The non-volatile storage 806 may include one or more persistent data storage devices such as a hard drive, optical drive, tape drive, non-volatile solid-state device, cloud storage or any other device capable of persistently storing information.

The processor 804 may be configured to read into memory 802 and execute computer-executable instructions residing in program instructions 808 of the non-volatile storage 806 and embodying algorithms and/or methodologies of one or more embodiments. The program instructions 808 may include operating systems and applications. The program instructions 808 may be compiled or interpreted from computer programs created using a variety of programming languages and/or technologies, including, without limitation, and either alone or in combination, Java, C, C++, C#, Objective C, Fortran, Pascal, Java Script, Python, Perl.

Upon execution by the processor 804, the computer-executable instructions of the program instructions 808 may cause the computing device 800 to implement one or more of the algorithms and/or methodologies disclosed herein. The non-volatile storage 806 may also include program data 810 supporting the functions, features, and processes of the one or more embodiments described herein.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

1. A mobile device for configuration of signal strength calibration offset, comprising:
a wireless transceiver configured for location of the mobile device by a vehicle; and
a processor programmed to
display a user interface for configuration of a signal strength offset of the wireless transceiver to the vehicle, the user interface including a visualization of a size of a passive zone overlaid on an image of the vehicle, the signal strength offset being an offset with respect to a default calibration of signal strength measurements between the wireless transceiver and the vehicle, the signal strength calibration being for use in calibrating the location of the mobile device for the passive zone with respect to the vehicle,
receive an update to the signal strength calibration from the user interface,
increase or decrease the size of the passive zone in the user interface to show the update in the signal strength offset, and
send the signal strength calibration as updated to the vehicle for use in locating the mobile device for the passive zone.

2. The mobile device of claim 1, wherein the processor is further programmed to:
display a calibration control for selection when the mobile device is at a location of a desired transition for the passive zone;
responsive to the selection of the calibration control, record the signal strength calibration as a difference in the signal strength between the wireless transceiver and the vehicle from the default calibration; and
utilize the difference as the update to the signal strength calibration.

3. The mobile device of claim 1, wherein the processor is further programmed to:
display a first control for increasing the signal strength offset for the passive zone;
display a second control for decreasing the signal strength offset for the passive zone; and
receive the update in the signal strength calibration from one or more of the first and second controls,
wherein the size of the passive zone is increased in the user interface responsive to receipt of input to the first control, and the size of the passive zone is decreased in the user interface responsive to receipt of input to the second control.

4. The mobile device of claim 1, wherein the passive zone is a passive entry zone, and the signal strength offset is configured to determine a boundary of the passive entry zone with respect to the location of the mobile device.

5. The mobile device of claim 1, wherein the passive zone is a passive start zone, and the signal strength offset is configured to determine a boundary of the passive start zone with respect to the location of the mobile device.

6. The mobile device of claim 1, wherein the processor is further programmed to:
display a disable option to disable use of the passive zone; and
disable the use of the passive zone responsive to selection of the disable option.

7. The mobile device of claim 1, wherein the processor is further programmed to:
display administrator calibration settings for the vehicle;
receive a selection of the mobile device from a user listing of the administrator calibration settings; and
configure the signal strength offset for the mobile device responsive to the selection.

8. The mobile device of claim 7, wherein the processor is further programmed to configure the administrator calibration settings via a server in communication with the vehicle and the mobile device.

9. The mobile device of claim 1, wherein the processor is further programmed to set the default calibration in accordance with a security vs performance setting, such that a preference for performance utilizes a default calibration with a greater boundary than a preference for security.

10. A method for configuration of signal strength calibration offset, comprising:
displaying, to a screen of a mobile device, a user interface for configuration of a signal strength offset of a wireless transceiver to a vehicle, the user interface including a visualization of a size of a passive zone overlaid on an image of the vehicle, the signal strength offset being an offset with respect to a default calibration of signal strength measurements between the wireless transceiver and the vehicle, the signal strength calibration being for use in calibrating a location of the mobile device for the passive zone with respect to the vehicle;
receiving an update to the signal strength calibration from the user interface;
increasing or decreasing the size of the passive zone in the user interface to show the update in the signal strength offset; and
sending the signal strength calibration as updated to the vehicle for use in locating the mobile device for the passive zone.

11. The method of claim 10, further comprising:
displaying a calibration control for selection when the mobile device is at a location of a desired transition for the passive zone;
responsive to the selection of the calibration control, recording the signal strength calibration as a difference in the signal strength between the wireless transceiver and the vehicle from the default calibration; and
utilizing the difference as the update to the signal strength calibration.

12. The method of claim 10, further comprising:
displaying a first control for increasing the signal strength offset for the passive zone;
displaying a second control for decreasing the signal strength offset for the passive zone; and
receiving the update in the signal strength calibration from one or more of the first and second controls,
wherein the size of the passive zone is increased in the user interface responsive to receipt of input to the first control, and the size of the passive zone is decreased in the user interface responsive to receipt of input to the second control.

13. The method of claim 10, wherein the passive zone is a passive entry zone, and the signal strength offset is configured to determine a boundary of the passive entry zone with respect to the location of the mobile device.

14. The method of claim 10, wherein the passive zone is a passive start zone, and the signal strength offset is configured to determine a boundary of the passive start zone with respect to the location of the mobile device.

15. The method of claim 10, further comprising:
displaying a disable option to disable use of the passive zone; and
disabling the use of the passive zone responsive to selection of the disable option.

16. The method of claim 10, further comprising:
displaying administrator calibration settings for the vehicle;
receiving a selection of the mobile device from a user listing of the administrator calibration settings; and
configuring the signal strength offset for the mobile device responsive to the selection.

17. A non-transitory computer-readable medium comprising instructions for configuration of signal strength calibration offset, that, when executed by a processor of a mobile device, cause the mobile device to perform operations including to:
display, to a screen of a mobile device, a user interface for configuration of a signal strength offset of a wireless transceiver to a vehicle, the user interface including a visualization of a size of a passive zone overlaid on an image of the vehicle, the signal strength offset being an offset with respect to a default calibration of signal strength measurements between the wireless transceiver and the vehicle, the signal strength calibration being for use in calibrating a location of the mobile device for the passive zone with respect to the vehicle;
receive an update to the signal strength calibration from the user interface;
increase or decrease the size of the passive zone in the user interface to show the update in the signal strength offset; and
send the signal strength calibration as updated to the vehicle for use in locating the mobile device for the passive zone.

18. The medium of claim 17, further comprising instructions that, when executed by the processor of the mobile device, cause the mobile device to perform operations including to:
display a calibration control for selection when the mobile device is at a location of a desired transition for the passive zone;
responsive to the selection of the calibration control, record the signal strength calibration as a difference in the signal strength between the wireless transceiver and the vehicle from the default calibration; and
utilize the difference as the update to the signal strength calibration.

19. The medium of claim 17, further comprising instructions that, when executed by the processor of the mobile device, cause the mobile device to perform operations including to:
display a first control for increasing the signal strength offset for the passive zone;
display a second control for decreasing the signal strength offset for the passive zone; and
receive the update in the signal strength calibration from one or more of the first and second controls,
wherein the size of the passive zone is increased in the user interface responsive to receipt of input to the first control, and the size of the passive zone is decreased in the user interface responsive to receipt of input to the second control.

20. The medium of claim 17, wherein the passive zone is a passive entry zone, and the signal strength offset is configured to determine a boundary of the passive entry zone with respect to the location of the mobile device.

21. The medium of claim 17, wherein the passive zone is a passive start zone, and the signal strength offset is configured to determine a boundary of the passive start zone with respect to the location of the mobile device.

22. The medium of claim 17, further comprising instructions that, when executed by the processor of the mobile device, cause the mobile device to perform operations including to:
display a disable option to disable use of the passive zone; and
disable the use of the passive zone responsive to selection of the disable option.

23. The medium of claim 17, further comprising instructions that, when executed by the processor of the mobile device, cause the mobile device to perform operations including to
display administrator calibration settings for the vehicle;
receive a selection of the mobile device from a user listing of the administrator calibration settings; and
configure the signal strength offset for the mobile device responsive to the selection.
